(19) United States
(12) Patent Application Publication
(10) Pub. No.: US 2017/0356791 A1
(43) Pub. Date: Dec. 14, 2017

(54) NOISE ISOLATION AUDIO FREQUENCY CLIP

(71) Applicant: Gerald Rogers, Dallas, TX (US)

(72) Inventor: Gerald Rogers, Dallas, TX (US)

(21) Appl. No.: 15/433,227

(22) Filed: Feb. 15, 2017

Related U.S. Application Data
(60) Provisional application No. 62/392,833, filed on Jun. 13, 2016.

(51) Int. Cl. G01H 1/00; H04M 1/725

(52) U.S. Cl. CPC G01H 1/00; H04M 1/72527

(57) ABSTRACT

A vibration sensor device can be used with smartphones, tablets and computers with application software for measuring vibration frequency, damping coefficient and scale factor isolating the measurement to the specific area of the vibration sensor clamped to the vibrating system. Vibration sensor powered by the microphone bias found with CTIA and OMTP compatible systems and does not require batteries or external power.

### FIELD OF THE INVENTION

The present invention is generally related to devices, systems and methods for measuring vibration. More particularly, the invention relates to a vibration sensor device capable of delivering a signal to a smartphone, tablet or any device with a CTIA (The Wireless Association, originally known as the Cellular Telephone Industries Association) headset jack.

### BACKGROUND OF THE INVENTION

Software applications for smartphones and tablets using the embedded sensors are pervasive in the market. These smartphone and tablet applications have moved expensive test instruments into low cost software available to hundreds of millions of smartphone and tablet owners. One category of applications uses an embedded accelerometer for a vibration sensor to measure the vibration of machinery, instruments and other items.

Software applications developed for the smartphones, tablets and other devices use the embedded accelerometers for sensing vibration. The size and format of the smartphone and tablets with the embedded accelerometer limits where and what can be evaluated for vibration. The physical size and inability to isolate the unit or object under test limits the use of the smartphone and tablet applications to those objects that are or can be isolated from the environment for sensing just the vibrations coming from the unit or object under test. Additionally, access to the point of test on the object may not be available to the smartphone due to the minimal area for restricted area for accessing the point of test being smaller than the physical size of the smartphone.

### SUMMARY OF INVENTION

The present invention incorporates a vibration sensor and a low power amplifier in a small housing connected to a CTIA compatible cable and plug for attaching to a smartphone, tablet or device with a CTIA jack. The incorporated amplifier provides the smartphone, tablet or other devices with a vibration signal from the sensor representing the vibration of the object to be measured and draws power to generate the vibration signal from the microphone bias output from the CTIA jack eliminating a need for batteries or other sources of power.

### BRIEF DESCRIPTION OF THE DRAWINGS

FIG. 1 is a block diagram of the vibration sensor system.

FIG. 2 is electric motor pump system illustration diagnostics vibration sensor application.

FIG. 3 illustration of an instrument vibration application with clip sensor.

### DETAIL DESCRIPTION OF THE INVENTION

In the following description, the various embodiments of the present invention will be described in detail. However, such details are included to facilitate understanding of the invention and to describe the preferred embodiment of the invention. Such details should not be used to limit the invention to the particular embodiments described because other variations and embodiments are possible while staying within the scope of the invention. Furthermore, although numerous details are set forth in order to provide a thorough understanding of the invention, it will be apparent to one skilled in the art that these specific details are not required to practice the invention. In other instances, details such as well-known methods, electrical circuit, processes, and interfaces are illustrated in block diagram form so as to not obscure the present invention.

The invention includes a vibration sensor connected to an amplifier which may be low power integrated into a connection device which may be a clip electrically connected with a CTIA compatible cable to plug into the smartphone, tablet or computing device. The invention may be powered from the CTIA jack microphone bias voltage.

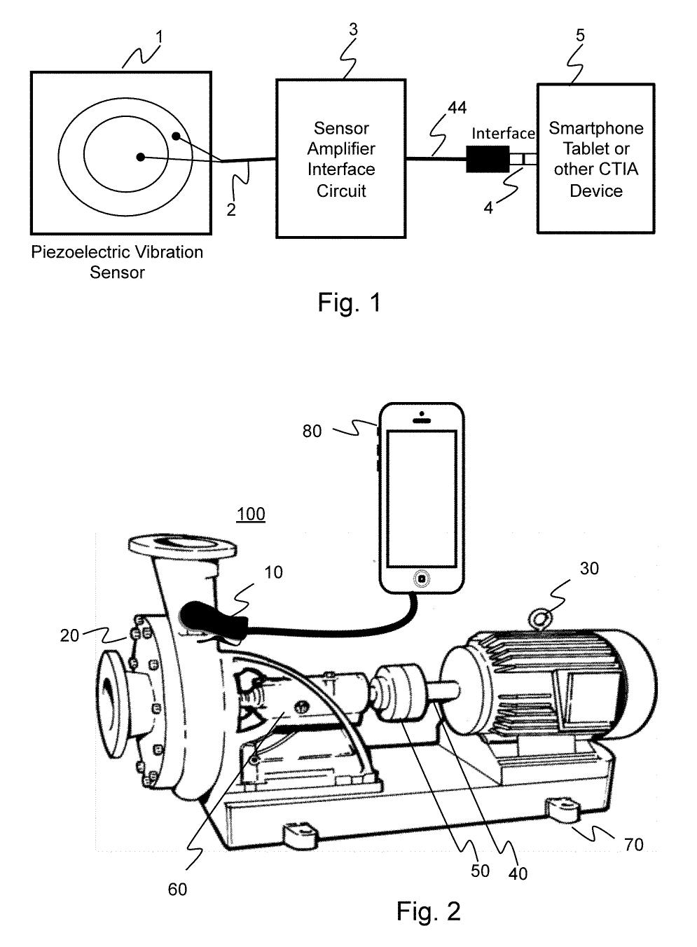

With reference to FIG. 1, a block diagram of the sensor system according to one embodiment of the invention. As shown in FIG. 1, Vibration Sensor 1 may be electronically connected for example by a wire 2 to the Sensor Amplifier 3 which may sense the vibration and generate a vibration signal which corresponds to the vibration of the object to be measured, and the vibration signal may be amplified for transmitting through the CITA compatible cable 44 and the plug 4 to the Smartphone, Tablet or other CITA compatible device 5. CTIA and an open mobile terminal platform OMTP headset with microphone standards may use a 4 pole or contact jack with one of the contacts of the jack for a microphone input.

FIG. 2 shows an electric motor water pump system 100 being diagnosable with the present invention and a smartphone application such as illustrated in FIG. 1. Vibration from the water pump system 100 may be generated by a loose component such as retaining bolts 70; or shaft 40, worn bearing; or coupler 50 worn or out of alignment. Water pump 20 may be the source of the vibration indicating trouble, and the vibration from the water pump 20 can be detected with a connector to connect to the object such as the motor water pump system 100 for example a clip 10 and a vibration application on smartphone 80. Vibration sensor clip 10 can be attached to motor 30, shaft housing 60 or retaining bolt 70 in addition to the water pump for isolating vibration and identifying the problem. The significant advantage of the invention is to be able to be physically attached to the object to be measured by a smartphone embedded accelerometer.

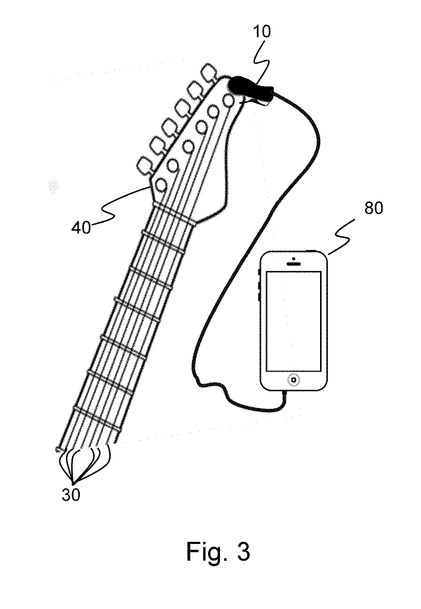

FIG. 3 illustrates using the invention with an instrument and smartphone application measuring the frequency of the vibration of the instrument. Guitar 40 may vibrate when one or more of the strings 30 are picked, plucked, strummed, etc. The clip 10 may be firmly clipped to the stock or other location of the guitar 40 to sense the vibration of the guitar 40. The vibration sensor and amplifier housed in clip 10 transmits the amplified vibration frequency of the vibration signal to the application running on the smartphone 80.

Present invention will work with several applications or programs used on the electronic processing device. These applications or programs vary the data of the vibration signal to display the frequency obtained thru the interface of this invention. Error rate of the vibration signal may be obtained from the standard Frequency Analysis of the vibration signal acquired. Some embodiments may also record the vibration signal acquired to be played back or be displayed at a later time. The electronic device can be but not limited to Smart Phone 80; Tablet; Note Books; Computers independent of the operating system which may support the application or program being used and may have a CTIA or OMTP jack. This invention may be also independent to the display size or resolution of the electronic processing device as long as it supports the application or program being used.

What is claimed is:

1. A sensor device comprising:
a vibration sensor housed in a mechanism for attaching to a vibrating device;
an electronic circuit amplifier wired to the vibration sensor housed in said mechanism;
an electric cable wired between the amplifier and a 4-pole plug, and said 4-pole plug supplies power to the amplifier and connects the amplified vibration signal to the computing device.

2. The sensor device according to claim 1, further comprising a clamp for mechanically mounting the device on a vibrating instrument or system.
